(19) United States
(12) Patent Application Publication
(10) Pub. No.: US 2017/0165859 A1
(43) Pub. Date: Jun. 15, 2017

(54) DEVICE FOR SEPARATING FLEXIBLE PACKAGING ELEMENTS

(71) Applicant: CELLPACK AG, Villmergen (CH)

(72) Inventors: Martin KROPF, Münchenbuchsee (CH); Thomas JOSI, Worben (CH); Rolf WIRZ, Hasle bei Burgdorf (CH)

(21) Appl. No.: 15/324,236

(22) PCT Filed: Jul. 7, 2015
(86) PCT No.: PCT/EP2015/065451

§ 371 Date: Jan. 5, 2017

(30) Foreign Application Priority Data
Jul. 9, 2014 (EP) 14176377.1

(51) Int. Cl. B26D 7/18; B26D 7/01; B65B 61/06; B26D 1/08

(52) U.S. Cl. CPC B26D 7/1863; B26D 1/085; B26D 7/015; B65B 61/06; B26D 2007/0018

(57) ABSTRACT

The device serves to separate flexible packaging products (4) that have been cut out from a web (3), more particularly packaging bags, from waste parts (5). To this end, a transport device (1) for transporting the web (3) along a transport path (2) and a workstation (8) for cutting out the packaging products (4) from the web (3) are provided. The transport device (1) is provided with means (14, 23) for selectively retaining and releasing packaging products (4) and waste parts (5). Further workstations (9 to 12) are arranged along the transport path (2), at least one of which is provided with means for selectively picking up packaging products (4) and waste parts (5), respectively, that are located on the transport device (1). It is thus achieved that both the packaging products (4) and the waste parts (5) are always retained until they are laid down in a container intended therefor and are never in an uncontrolled state.

The invention relates to a device according to the preamble of claim 1.

Different punching and cutting methods are known for cutting out packaging products from a web-shaped film material. In a procedurally simple case, the packaging products are cut out from the web and the remaining grid-shaped waste is rolled up. When waste parts that cannot be rolled up as a grid are produced in the punching or cutting method being applied and/or due to the nature, more particularly the contours of the packaging products, however, an automatic separation becomes substantially more difficult for the following reasons.

It is known in the art to wipe off waste parts mechanically and to subsequently drop them into a container or extract them by suction. Yet, especially with light film materials, this method does not work reliably since static charges may cause uncontrolled flights of the waste parts over large distances so that they may adhere somewhere and thus disturb the production process, jeopardize the quality of the packaging products or even damage the production facility. In the worst case, film clippings may enter into the interior of a packaging product and in the case of foodstuff packages might endanger consumers. Similar problems arise in the case of an excessive or a very low tendency to slide of the film material. As a result, in current packaging production facilities, an expensive process control by personnel is required in order to remove accumulations of entangled waste parts.

But also the automatic handling of the packaging products is quite problematic in known production methods, especially when the packaging products are packaging bags that are provided with weld-in parts such as pouring spouts. If such packaging bags are released, e.g. dropped, after cutting them out, it is very difficult to restore a defined orientation and arrangement thereof for further processing, e.g. packaging.

Ultimately, it is very difficult in the known production processes to handle more than two kinds of cut products, i.e. packaging products and waste parts, automatically and with high reliability. In addition to these two cut products, it would be desirable to be able to automatically lay down e.g. faultless packaging products, defective packaging products, packaging products selected for control purposes and possibly waste parts of different types in determined locations. Currently no method is known in which these parts are not temporarily released, in which case the aforementioned problems may arise.

On the background of this prior art it is the object of the invention to suggest a method for cutting out packaging products from a web where disturbances of and damage to the production facility and to the packaging products by uncontrolled movements of waste parts or packaging products are reliably avoided.

According to the invention, this object is achieved by the features defined in the characterizing part of claim 1.

In particular, this inventive solution offers the advantage that the selective retaining and releasing means and the selective pickup means can be controlled such that no packaging product and no waste part is accidentally dropped but these parts can instead be delivered to a placement area in a controlled manner. Moreover, especially the packaging products can be laid down by the selective pickup means in a defined orientation or forwarded for further processing, e.g. for being filled. All in all, the invention results in a device that allows a fully automated, quick, and inexpensive production of packaging products and is simple and inexpensive to manufacture.

Particular embodiments of the invention are described in the dependent claims.

The invention also relates to a method for operating the device.

Exemplary embodiments of the invention will be explained hereinafter with reference to the accompanying drawings showing

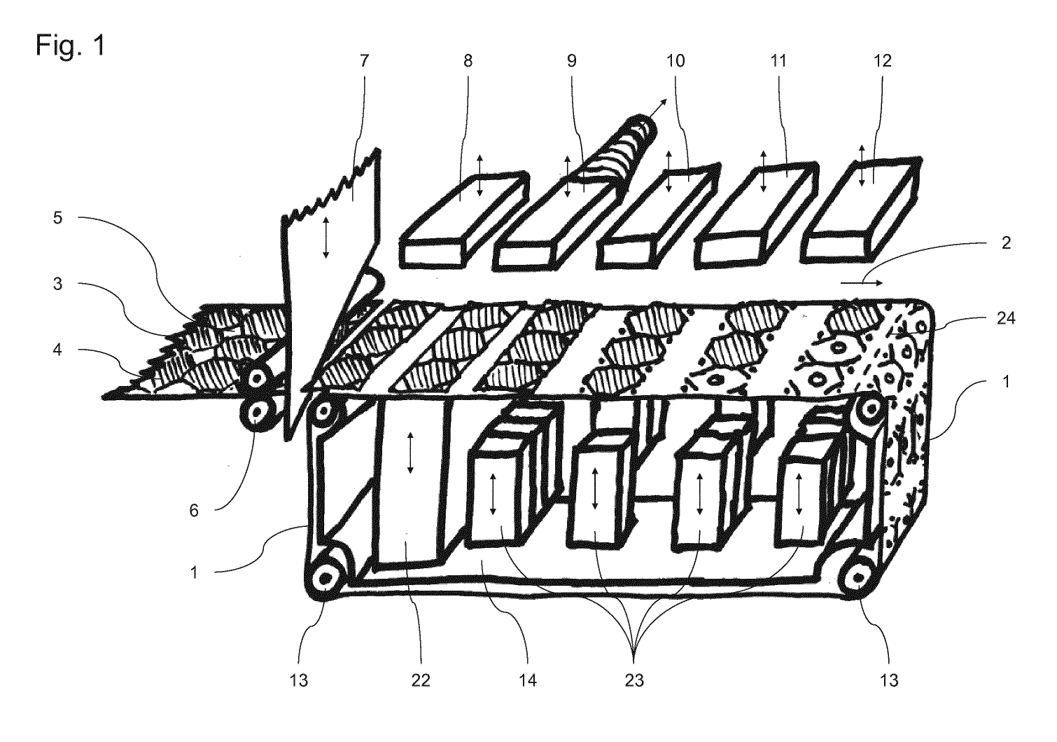

FIG. 1 a schematic perspective view of a first exemplary embodiment of the device of the invention;

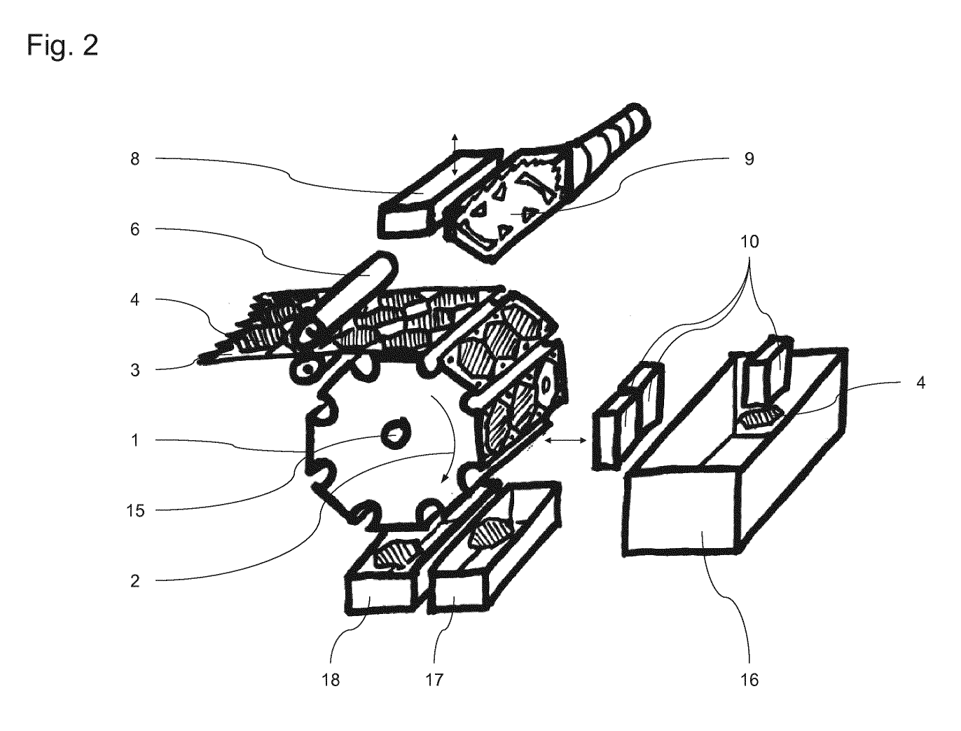

FIG. 2 a schematic perspective view of a second exemplary embodiment of the device of the invention; and

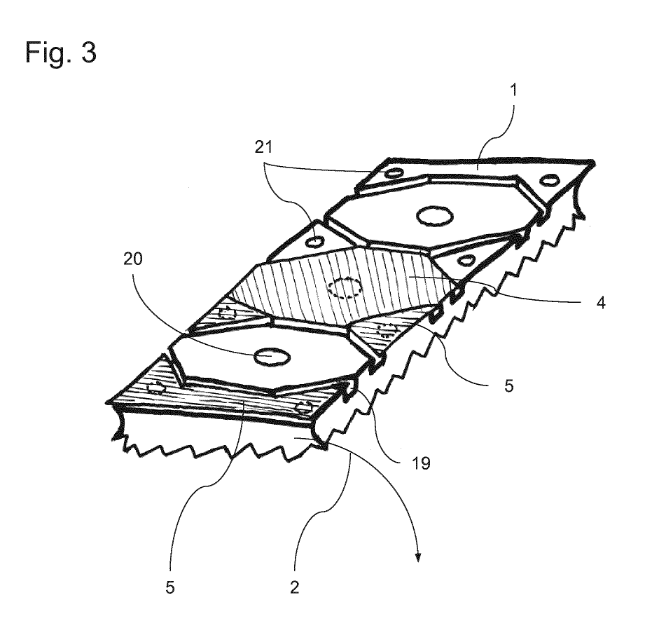

FIG. 3 a detail of FIG. 2 on an enlarged scale relative to FIG. 2.

A central element of the invention consists in a transport device 1 which in the exemplary embodiment according to FIG. 1 is designed as an endless transport belt 1. Transport device 1 is equipped with means to be described below by which packaging products 4 produced from a web 3 of film material and waste parts 5 are retained on transport device 1 and transported along a transport path 2. Web 3 e.g. consists of two superposed film layers of a synthetic material that are welded together. The partial weld joints delineate packaging products, e.g. packaging bags for liquids. In FIG. 1, web 3 is used in 3-up operation, i.e. three packaging products 4 at a time are arranged thereon side by side. Web 3 may be supplied from a supply roll or directly taken over from a production facility for the packaging products 4 while a buffer segment may possibly be interposed which is known per se and is not an object of the present invention. In the illustrated exemplary embodiment, a feed roller pair 6 feeds the web section by section to transport device 1, where each section is retained before being cut off from web 3 by a cutting blade 7.

For selectively retaining packaging products 4 and waste parts 5 on the band conveyor, a vacuum chamber 14 is arranged in a section of transport path 2 on the surface of the band conveyor opposite packaging products 4 and waste parts 5. Through suction openings in the band conveyor, packaging products 4 and waste parts 5 are aspirated and thus retained on the band conveyor. In principle, the band conveyor may consist of any material that is air-tight and sufficiently flexible to be guided over deflection rollers 13. Preferentially, the band conveyor consists of a thin steel sheet material. To drive the band conveyor, one of deflection rollers 13 may be equipped with a non-represented motor, for example. Deflection rollers 13 and the drive of the band conveyor are arranged outside vacuum chamber 14, as illustrated by demarcation 24 indicated by a broken line.

In the depicted example, five workstations 8 to 12 are arranged along transport path 2 in FIG. 1 above the upper strand of the band conveyor. Among those, 8 is a cutting station which cuts out packaging products 4 from web 3. Corresponding recesses therefor may be provided in the band conveyor along the outline of packaging products 4, and below the band conveyor, a corresponding counter tool may be arranged inside vacuum chamber 14. It is not possible to provide the band conveyor with cutouts that correspond to the contours of the packaging products for cutting out the packaging products since such cutouts would be too large and would make it impossible to maintain a vacuum. However, web 3 may either already be provided with partial cuts on part of the outline of the packaging products 4 or an additional cutting station may be provided, in which case cutting station 8 and the additional cutting station each operate partial cuts for a respective packaging product which together cover the entire circumference of the packaging products so that the latter are no longer connected to web 3 after the additional cutting station but are still being aspirated on the band conveyor. Alternatively it is also possible in order to cut out the contour of the packaging products to arrange cutting tools in workstation 8 which use the band conveyor as the counter tool while the band conveyor has no recesses for an immersion of the cutting tools.

Workstation 9 is designed as an extraction station for waste parts 5, the device being automatically controlled such that the waste parts are only released by transport device 1 when they are in the sphere of action of the extraction station and the latter has been moved into position and switched on. In this manner, waste parts 5, which are often relatively small, are never in an uncontrolled condition in which they might fly away due to air draft or electrostatic charge and get caught somewhere. The extraction station may be provided with a tube for discharging the extracted waste parts 5, as indicated in the figure, or designed so as to aspirate waste parts 5 and place them in a container beside or above the band conveyor.

In the depicted example, workstation 10 is designed as a pickup station for correctly produced packaging products 4, for which purpose it is also equipped with corresponding suction means and designed so as to be able to lay down the picked up packaging products 4 in a container intended therefor. An independent suction means is provided for each item of the multi-up production. Here also the control principle applies according to which the packaging products 4 are only released by transport device 1 when they are in the sphere of action of the pickup station and the latter has been moved into position and activated.

In principle, workstations 11 and 12 may be of similar construction as the previously described workstation 10 and only differ in their purpose and thus in the manner in which they are controlled. Thus, for example, workstation 11 might be used for sorting out faulty packaging products 4 and workstation 12 for withdrawing packaging products 4 as test samples. The control of workstation 11 for singling out faulty packaging products may be based on signals from a preceding workstation or from a test device integrated in a preceding workstation. The activation of workstation 12 for singling out test samples may be programmed in the control system of the device or based on a manually entered command of an operator.

For selectively releasing packaging products 4 and waste parts 5 from transport device 1, in the exemplary embodiment according to FIG. 1, control bodies 23 are arranged in vacuum chamber 14 which are movable toward and away from the band conveyor in order to close or open selected suction openings in the band conveyor, respectively. These control bodies may correspond to the shape and surface area of a packaging product 4 or waste part 5 in order to release these parts in a targeted manner.

FIG. 2 shows another exemplary embodiment of the device where components that are identical or correspond to the exemplary embodiment previously described with reference to FIG. 1 are designated by the same reference numerals. In this exemplary embodiment, transport device 1 is designed as a drum so that transport path 2 describes a circular path. Web 3 with packaging products 4 is visible on the left of the Figure and is fed section by section onto the transport device by a feed roller pair 6 here also. A preceding cutting blade as in the embodiment according to FIG. 1 is not required here since the drum may be provided with recesses, as will be explained below with reference to FIG. 3. Therefore, workstation 8 in the form of a cutting station can be used both for cutting off sections of web 3 and for cutting out packaging products 4.

The workstations are arranged along circular transport path 2, only workstations 8 to 10 being depicted in FIG. 2. Further workstations may be located below the drum but are not illustrated. Functional parts for the selective retention of packaging products 4 and waste parts 5 on the drum by means of vacuum are arranged inside the drum. These may operate similarly as previously described with reference to FIG. 1. Alternatively, however, non-represented vacuum lines may lead to corresponding locations on the inner circumference of the drum and be controlled by non-represented vacuum valves arranged inside or outside the drum. In FIG. 2 a vacuum connection 15 is schematically illustrated which may be designed in a known manner as a rotary connection.

As seen on the right of the Figure near workstation 10, the latter may be divided so as to allow each part 10 to be separately moved for each multi-up item on web 3, e.g. three of them. This applies to all mentioned workstations including those of the exemplary embodiment of FIG. 1. Ultimately, collecting containers 16, 17 and 18 for faultless packaging products, defective packaging products and test samples are furthermore illustrated in FIG. 2.

FIG. 3 shows a segment of workstation 1 of the embodiment according to FIG. 2 in the form of a drum on an enlarged scale relative to FIG. 2. A packaging product 4 and three waste parts 5 of two different shapes and sizes are arranged on the segment and illustrated by hatched areas. Recesses 19 are intended for the immersion of cutting tools by which the packaging products are cut out from web 3. Also, suction openings 20 for the packaging products 4 and further suction openings 21 for waste parts 5 are visible in

FIG. 3. All suction openings 20, 21 can be connected to corresponding vacuum lines inside the drum.

In the exemplary embodiments previously described with reference to FIGS. 1 to 3, the transport device is in the form of a band conveyor or a drum, respectively, and the selective retention means and the selective pickup means are in the form of suction devices. The invention is not limited thereto, however, but the band conveyor may e.g. be divided into several narrow band conveyors or be designed as a transport chain or as transport chains. Also, the selective retaining means and the selective pickup means may be designed as gripping means or as needles which retain the packaging products and the waste parts by clamping or piercing them. The selective release of the mentioned parts may then be achieved by elements that are arranged along the transport path and open the gripping means or wipe the mentioned parts off the needles, respectively.

The exemplary embodiments show possible realizations of the device, but it should be noted at this point that the invention is not limited to the depicted particular embodiments thereof. Instead, individual components described with reference to a particular embodiment may e.g. be used in another embodiment and may possibly replace a corresponding component described with reference to that embodiment. Therefore, all conceivable embodiment variants resulting from combinations of individual details of the depicted and described embodiment variants are also encompassed in the scope of protection.

Ultimately, as a matter of form, it should be pointed out that for a better understanding of the construction of the device, the latter and its components, respectively, are illustrated schematically and not true to scale.

### LIST OF REFERENCE NUMERALS

1 transport device
2 transport path
3 web
4 packaging product
5 waste part
6 feed roller pair
7 cutting blade
8 workstation
9 workstation
10 workstation
11 workstation
12 workstation
13 deflection rollers
14 vacuum chamber
15 vacuum connection
16 collecting container
17 collecting container
18 collecting container
19 recess
20 suction opening
21 suction opening
22 counter tool
23 control body
24 demarcation

1. Device for cutting out flexible packaging products, more particularly packaging bags, from a web, comprising a transport device for transporting the web along a transport path and a workstation for cutting out the packaging products from the web, wherein the transport device is provided with means for selectively retaining and releasing packaging products and waste parts on the transport device, and further workstations are arranged along the transport path, at least one of which is provided with means for selectively picking up packaging products and waste parts, respectively, that are located on the transport device.

2. Device according to claim 1, wherein the transport device is designed as a band conveyor.

3. Device according to claim 1, wherein the transport device is designed as a rotating drum.

4. Device according to claim 1, wherein the means for selectively retaining and releasing packaging products and waste parts on the transport device are designed as suction means.

5. Device according to claim 1, wherein the means for selectively picking up packaging products or waste parts, respectively, located on the transport device are designed as suction means.

6. Device according to claim 1, wherein the transport device is designed as a transport chain.

7. Device according to claim 6, wherein the means for selectively retaining and releasing packaging products and waste parts on the transport device are designed as gripping means or as needles for piercing the packaging products and waste parts.

8. Device according to claim 6, wherein the means for selectively picking up packaging products and waste parts, respectively, located on the transport device are designed as gripping means or as needles for piercing the packaging products and waste parts.

9. Device according to claim 1, wherein the workstation and the further workstations are movable toward the transport path and away from the transport path.

10. Method for operating the device according to claim 1, wherein each packaging product and each waste part located on the transport device is only released by the respective selective retaining and releasing means when a corresponding means for selectively picking up that particular packaging product or waste part has been activated.
